(19) United States
(12) Patent Application Publication
(10) Pub. No.: US 2008/0141433 A1
(43) Pub. Date: Jun. 19, 2008

(54) APPAREL HAVING VARIABLE COLOR LOGO AND TRIMMINGS

(76) Inventor: Temilade Stephen Rhodes-Vivour, Ozark, AL (US)

Correspondence Address: MERCHANT & GOULD PC, P.O. BOX 2903, MINNEAPOLIS, MN, 55402-0903, US

(21) Appl. No.: 12/037,119

(22) Filed: Feb. 26, 2008

Related U.S. Application Data
(63) Continuation-in-part of application No. 11/032,344, filed on Jan. 10, 2005.
(60) Provisional application No. 60/570,658, filed on May 12, 2004.

(51) Int. Cl. A41D 1/00; B05C 3/02; A43B 5/00; D06B 3/30

(52) U.S. Cl. 2/69; 8/115.51; 68/200; 36/83

(57) ABSTRACT

Discloses is an apparatuses and methods for varying a color of a portion of apparel. The apparatuses include a first reservoir comprising a first portion comprising a first dye when the first reservoir is in a first state, and a second portion comprising the first dye when the first reservoir is in a second state. The apparatuses also include a first air pouch proximate the first reservoir. The methods include locating a first reservoir on a surface of the apparel; and passing a first dye from a first opaque portion to a transparent or semitransparent portion. Passing the first dye from the first opaque portion to the transparent or semitransparent portion comprises inflating a first air pouch.

### CROSS-REFERENCE TO RELATED APPLICATIONS

This application is a Continuation-in-Part of U.S. application Ser. No. 11/032,344, filed Jan. 10, 2005, that claims priority to U.S. Provisional Application Ser. No. 60/570,658, filed on May 12, 2004, both of which priority is claimed to and are hereby incorporated by reference in their entirety.

### FIELD OF THE INVENTION

The present disclosure relates to apparel comprising logos and/or trimmings having at least one color that can be varied by a user.

### BACKGROUND

Currently consumers are limited to one color choice when purchasing footwear unless the consumers buy multiple pairs of footwear. For example, a consumer can purchase a pair of shoes having a white base with red logos and/or trimmings. If the consumer wants the same pair of shoes having a white base with blue logos and/or trimmings, the consumer must buy a second pair of shoes. As a result collecting footwear of similar styles but having different color logos and trimmings can become expensive for the consumer and occupy large amounts of storage space.

### SUMMARY

This invention pertains to an apparatus for varying a color of a portion of apparel. The apparatus comprises a first reservoir and a first air pouch proximate the first reservoir. The first reservoir comprises a first portion comprising a first dye when the first reservoir is in a first state, and a second portion comprising the first dye when the first reservoir is in a second state.

### BRIEF DESCRIPTION OF THE DRAWINGS

Non-limiting and non-exhaustive embodiments are described with reference to the following figures, wherein like reference numerals refer to like parts throughout the various views unless otherwise specified.

Non-limiting and non-exhaustive embodiments are described with reference to the following figures, wherein like reference numerals refer to like parts throughout the various views unless otherwise specified.

FIG. 1 shows a diagram of the variable color logo and trimming sneaker;

FIG. 2 shows a diagram of fixed and variable color filters;

FIG. 3 shows a side view diagram of inner and outer air pouches;

FIG. 4 shows a front view diagram of outer air pouch;

FIG. 5 shows a diagram of the exploded view of the variable color logo;

FIG. 6 shows a diagram showing alternate exploded view of variable color logo;

FIG. 7 shows a diagram of assembled variable color logo;

FIG. 8 shows a diagram showing the attachment of the variable color logo;

FIG. 9 shows a diagram of the sneaker pump system; and

FIG. 10 shows a bladder for housing a dye;

FIGS. 11A and 11B show a window having an elevated section;

FIG. 12 shows a pump; and

FIGS. 13A and 13B show an air pouch system.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims. Note that throughout this specification, the terms apparel, handbag, handbags, belt, belts, accessory, accessories, shoe, shoes, footwear, sneaker, sneakers, hat, headgear, headwear, and other terms indicating articles to be worn by a person may be used interchangeably.

Varying the color of apparel can be accomplished by color subtraction. Color subtraction entails superimposing a combination of color filters to produce a desired color. For example, passing white light through a red filter subtracts blue and green lights and the observed light is red. Another example would be passing white light through a magenta filter. The magenta filter subtracts green light and leaves a mixture of red and blue lights creating a magenta colored light.

In various aspects of the present invention, two filter types are used to vary the color of apparel, a fixed color filter and a variable filter. The fixed filter is fixed with respect to colors it filters and can be made from a thin colored plastic fashioned into a shape such as the shape of a desired logo and/or trimmings. In addition, the variable filter can be controlled such that the filter operates in varying states. A first state may be one in which the filter admits “white light”. A second state may be one in which only a single color is admitted. Note that admitting a color means light having that color is allowed to pass through the filter and filtering a color means subtracting that color light from light having combination of colors.

For example the fixed filter may filter blue light and the variable filter may filter green light. Therefore, when the variable filter is in the first state, only the fixed filter is subtracting blue light and the apparel's logo and/or trimmings would be yellow. When the variable filter is in the second state, variable filter would subtract green light and the apparel's logo and/or trimmings would be red. The color of the variable filter is determined by a dye color.

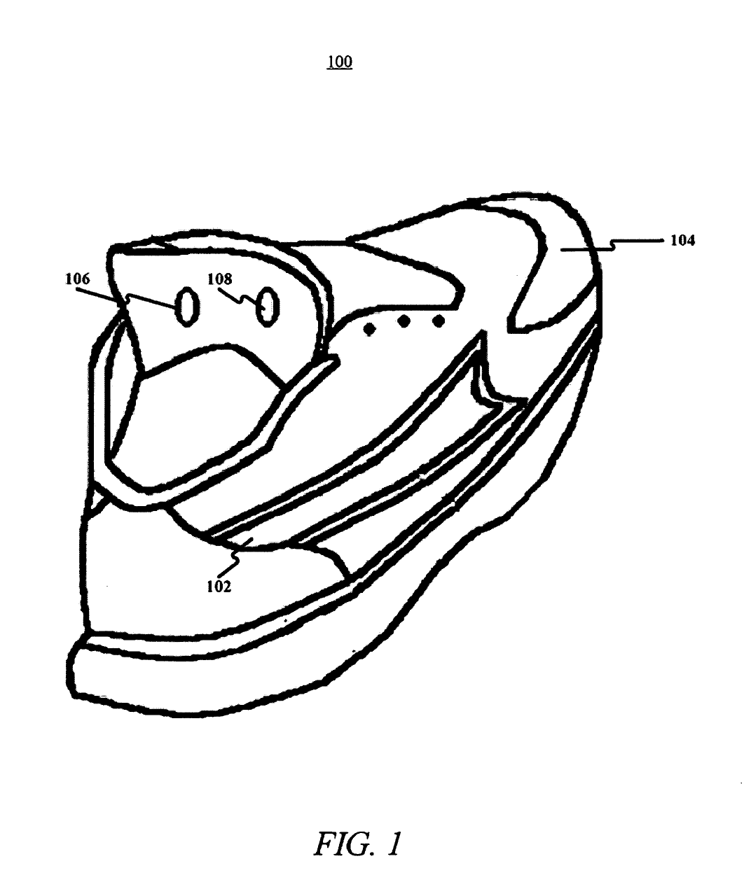

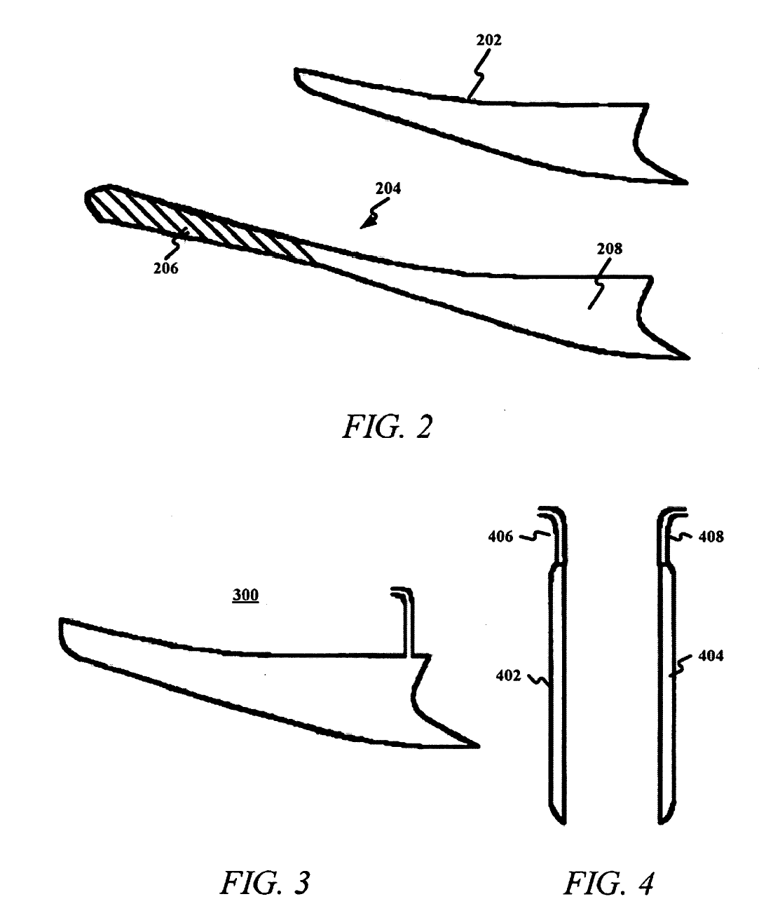

Turning now to the figures, FIG. 1 depicts a sneaker 100 fitted with a color changing logo 102 and color changing trimmings 104. Openings 106 and 108 are used to vary logos 102 and 104's color. FIG. 2 shows a fixed filter 202 and a variable filter 204. Variable filter 204 can be controlled by an applied force to a non-reservoir portion 208. This force can be pneumatic.

Variable filter 204 can be made from a thin colorless transparent plastic. In fabricating variable filter 204 two plastic sheets can be placed together and then heat stamped in a desired shape. One end of variable filter 204 should be left unsealed for the purpose of filling it with a dye having the desired color for color subtraction. Enough liquid dye should be added so that a thin layer of the dye fills non-reservoir portion 208. Reservoir portion 206 of variable filter 204 is denoted by the hatched area. After filling variable filter 204 with an appropriate amount of dye, variable filter 204's open end can then be heat sealed so that the dye is confined within variable filter 204. The same fabrication process can be used to fabricate variable filters for trimmings.

FIG. 3 shows the front view of an air pouch 300. Heat sealing methods used in fabricating variable filter 204 can be used to fabricate air pouch 300. Air pouch 300 can be fashioned in the shape of the desired logo and/or trimmings and are made from similar grades of plastic or two different grades of plastic. For example, two different grades of plastic can be used in fabricating air pouch 300 because one side air pouch 300 is inflated by internal air pressure. The side of air pouch 300 made from a first (i.e. lower) grade plastic is more responsive to internal pressure changes. It is this more responsive plastic that is placed in direct contact with variable filter 204. Placing the more responsive plastic in contact with variable filter 204 isolates air pouch 300's influence on variable color filter 204.

Consistent with various embodiments of the invention, differing types of air pouches can be used. For example, in footwear, tow air pouches, both of which are identical in various aspects except for the side of the air pouch that is allowed to inflate. For instance, FIG. 4 depicts two types of air pouches. An inner air pouch 402 inflates on the side facing toward the footwear surface (i.e. toward the space between a wearer's feet). An outer air pouch 404 inflates on the side facing away from the footwear surface (i.e. away from the space between the wearer's feet). In addition, air pouches 402 and 404 comprise air lines 406 and 408. Air lines 406 and 408 are to be connected to air pouches 402 and 404 in a manner that minimizes pressure leaks.

The operation of variable filter 204 in conjunction with an associated air pouch is as follows: if the air pouch is not inflated (i.e. its internal air pressure is roughly equal to atmospheric pressure), the dye contained in variable filter 204 is unperturbed and remains in non-reservoir region 208 (i.e. a non-active condition). If the air pouch is inflated (i.e. its internal air pressure is greater than atmospheric pressure), the air pressure forces the dye in variable filter 204 into reservoir 206 (i.e. an active condition). Any apparel component layer adjacent to variable filter 204 acts as a supporting force which compliments the air pouch's effect on variable filter 204. The dye, now in non-reservoir region 208 established the apparel's color. While reservoir 206 has been described as a clear plastic (i.e. transparent), it is contemplated that reservoir 206 may be a opaque or semitransparent material such that the dye is hide from view, causes another color changing effect, and, aesthetic effect.

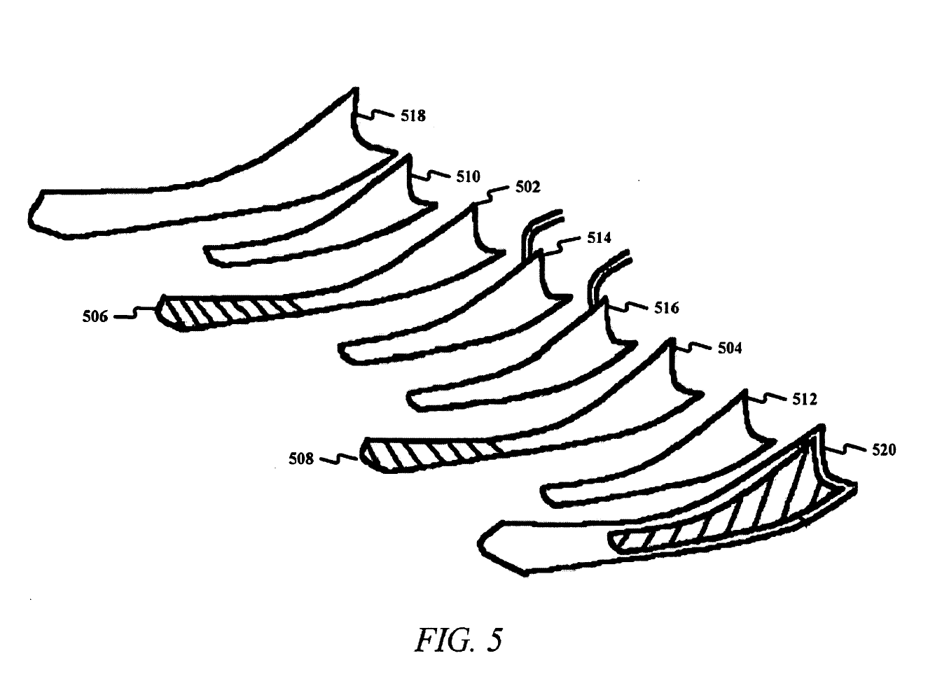

FIG. 5 gives an exploded view of various components of color changing logo materials. In FIG. 5 there are two variable filters 502 and 504, two fixed filter 510, backing 512, air pouches 514 and 516 and casings 518 and 520. Each variable filter 502 and 504 can filter different wavelengths (i.e. colors of light). For example, variable filter 502 can permit light having a wavelength corresponding to cyan to pass while variable filter 504 can permit light having a wavelength corresponding to yellow to pass. The hatched regions denoted by reference numerals 506 and 508 represent the reservoirs of variable filters 502 and 504, respectively. Backing 510 may be any color (e.g. white) and/or may be a colored piece of plastic, fabric, or other material that is cut in the shape of the desired logo and/or trimmings. Backing 510 can act as a reflector to reflect incident light back to an observer.

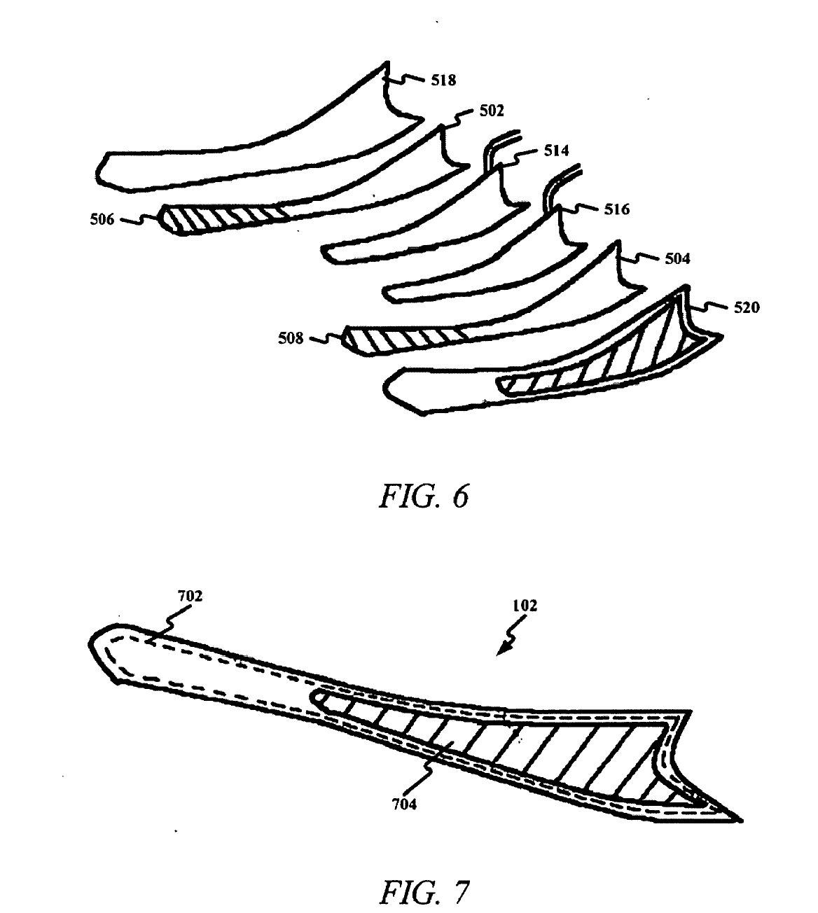

FIG. 6 shows an alternative to using backing 510. This alternative is to paint a portion of variable filter 502 or 504 a color (e.g. white, green, etc.). Painting a portion of variable filter 502 or 504 can eliminate the need for a separate layer to perform color reflection. This same alternate configuration can be used to eliminate the need for or in conjunction with a fixed color filter layer. In order to implement this alternate configuration, variable filter 502's painted portion can be painted the same color as the removed fixed filter.

As shown in FIG. 5, the active layers of the variable color logo 102 can be sandwiched between two pieces of sturdy, high-grade plastic (e.g. casing 518 and 520). Active layers are all the components lying between the casing 518 and 520. Casings 518 and 520 can act as a protective casing. Casing 520 can comprise a transparent portion, a semitransparent portion, painted as described above with reference to FIG. 6, and be made of a colored plastic, while the transparency of the back side is irrelevant. The perimeter of casings 518 and 520 should be greater than the perimeter of the active layers.

Casings 518 and 520 can be attached to one another by stitch or adhesive. The advantage of attaching casings 518 and 520 by stitch is that the attachment to a sneaker can be accomplished simultaneously. The assembled variable color logo 102 is shown in FIG. 7. FIG. 7 shows the stitching of the variable color logo 102. This stitching is denoted by reference numeral 702. The hatched region denoted by reference number 704 represents the area of variable color logo 102 that changes color. The area around region 704 can be painted the same or a different color as the apparel. The composition and fabrication of the color changing trimming material is analogous to the previously mentioned composition and fabrication methods of the color changing logo material.

The example described above in regards to FIG. 5 describes a color combination of magenta, yellow and cyan. This color combination provides four possible color options for the logo and/or trimming material: 1) pink; 2) red; 3) blue; and 4) black. These color options are determined by use of color perception theory. For example, 1) the combination of magenta (pink) and yellow equals red. The combination of pink and cyan equals blue and the combination of pink, yellow and cyan add to give black. Finally the absence of yellow and cyan leaves pink. The filter color combination can be set arbitrarily so as to provide the desired logo and/or trimming color options.

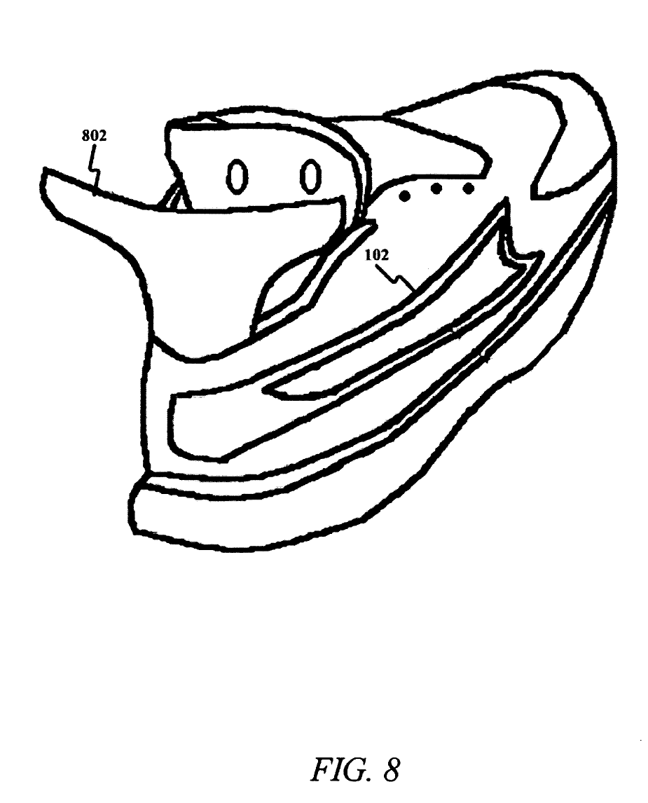

After variable color logo 102 has been assembled it can then be attached to sneaker 100. FIG. 8 gives a graphic depiction of this attachment. The leather flap 802 has been shown lifted for clarity. Next, variable color logo 102 is attached to sneaker 100 and leather flap 802 is lowered back into place. Finally, leather flap 802 is either stitched or glued to sneaker 100.

FIG. 9 shows one embodiment of a pump system 900 used to inflate the air pouches. Pump system 900 includes air pouch 514 (air pouch 516 is not shown), air lines 902, 904, 906, and 908 and a pump mechanism 910. Air lines 902 and 906 correspond to air pouch 514. Air lines 904 and 908 correspond to their respective air pouches in the color changing trimming. Air lines 902, 904, 906, and 908 should be placed so as to provide minimum intrusion. It is recommended that they be placed within the shoe lining.

Pump 910 is composed of three basic parts: a pump bulb 912, a pressure release valve 914, and an air line 916. Pump 910 should be fabricated to be as small as possible and placed on the inner side of the shoe tongue so as to be relatively non-intrusive. The exact specifications for pump 910 are left to the discretion of a manufacturer. The only stipulation for pump 910 is that it is discrete, non-bulky, and pressure release valve 914 should be placed on or near pump bulb 912.

The number of pumps needed can dependent on the desired number of distinct logo and/or trimming colors. For example, in order to produce four distinct colors two pumps may be need, one for each of the two variable filters. It is also contemplated that a single pump can be used to inflate the two air pouches associated with each of the two variable filters. It is also contemplated that the pump(s) may be permanently attached to the apparel or they may be removable from the apparel. Two colors are a result of the fixed filters and the combined effect of both the fixed filter and the variable filters. An increase in color options coincides proportionately with an increase in system complexity.

For operation of embodiments of the present invention, assume there are four distinct color options (i.e. there are two variable filters, two fixed filters, and two pumps). With two pumps the variable filters can operate independently of each other. For an initial condition, assume both variables filters' air pouches are not inflated. The logo's trimming's apparent color is approximately black. A next possible state occurs when one of the pumps is activated. This causes an air pouch to inflate which in turn forces the dye in a variable filter into a reservoir labeled, thus leaving the non-reservoir portion. As a result, the variable filter no longer acts as a color filter, but instead, allows all colors to pass. Now only one variable filter and a fixed filter remain to indicate a color. The combination of these filters causes the logo and trimming's color to appear a certain color (e.g. red).

A next possible state for this system occurs when the previously applied pressure is released and the second pump is activated. The release of the pressure of the first pump causes the previously inflated air pouch to deflate, which returns the filter to its original state (i.e. the shoe its original color). The activation of the second pump inflates a second air pouch and as a result dye in the second variable filter is forced into its reservoir leaving the non-reservoir area. Thus, the remaining filters (the variable color filter and the fixed filters) add to give the logo and trimming a second color (e.g. blue).

A fourth state of this system occurs when both pumps are activated. As a result, the dye in both variable filters are contained in their respective reservoirs and the non-reservoir areas of both variable color filters are left empty. This condition gives the logo and trimming a third color (e.g. pink). As previously mentioned, these color combinations are only one of many possible color combinations. Using different color filters will result in a separate set of color options for the logo and trimming.

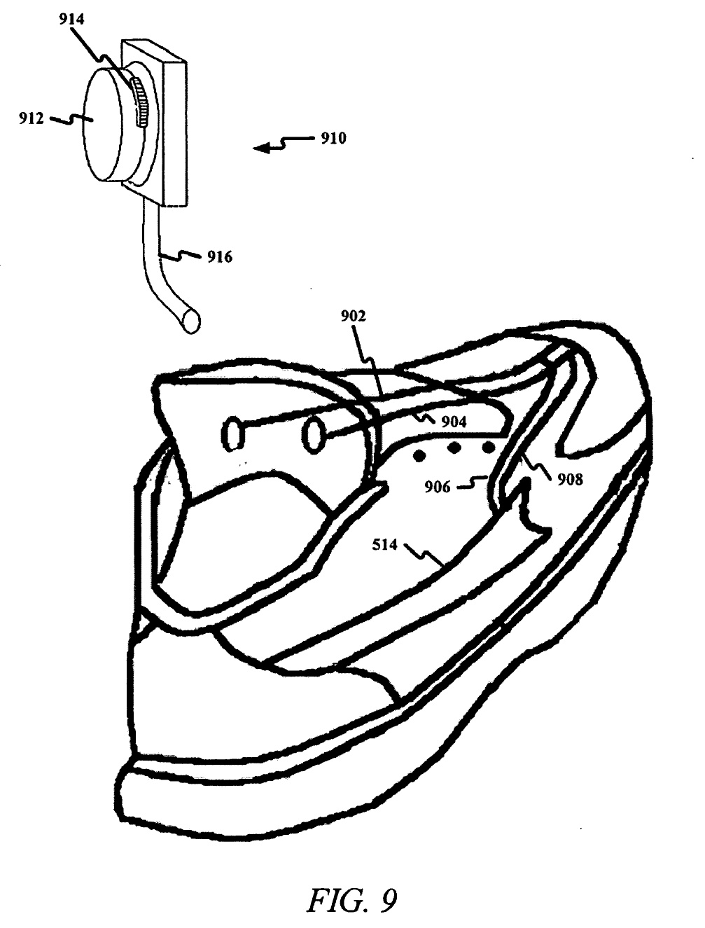

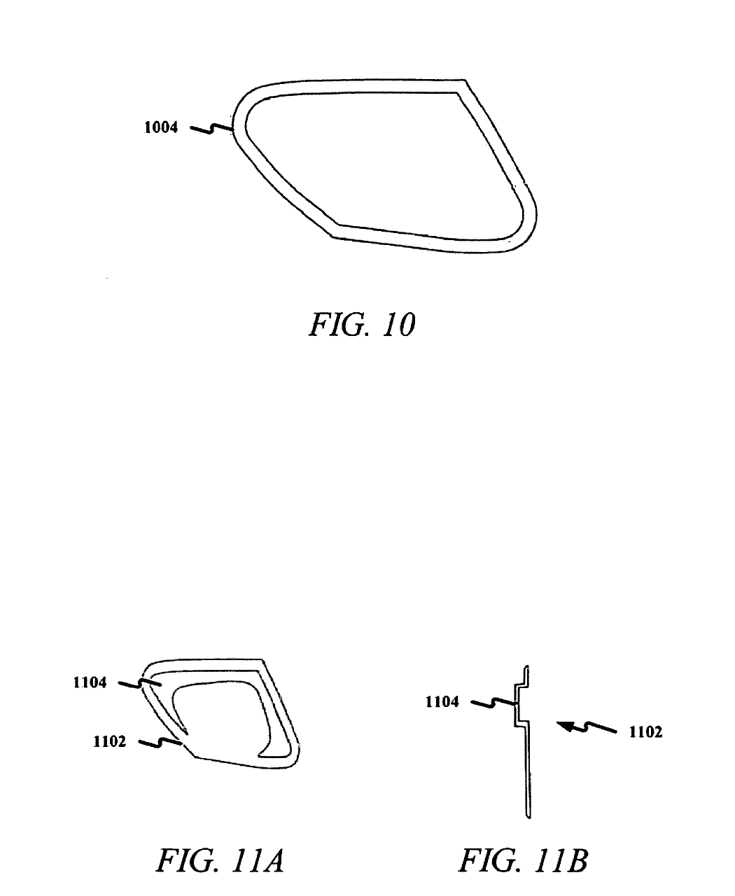

While FIGS. 1-9 depict variable filters and other components of an apparatus for varying the color of logos and/or trimmings having a length much greater than the height, it is contemplated that the components can have a length roughly equal to its height. For example, in FIG. 10 a bladder 1004 (i.e. a variable filter or reservoir) can have a transparent layer designed to hold a liquid dye or paint within a sealed self-contained area. As stated above, the liquid dye or paint's color contained within bladder 1004 is up to the discretion of the user. The rear side of bladder 1004 can be printed with a user's desired color. Note, the rear side of bladder 1004 is considered to be the side in direct contact with the air pouch.

Referring now to FIG. 11A, a window layer 1102 can be formed from transparent thermoplastic polyurethanes, possibly via injection molding techniques. Window 1102 can also be formed such that a logo 1104 is slightly elevated. For example, logo 1104 may be elevated 3 mm from the window layer 1102 (See FIG. 11B.). Window layer 1102 can represent a top layer of color changing logo stack (i.e. casing 520) and can offer both protection for and provide a window to the lower layers (e.g. air pouches, variable filters, and bladders).

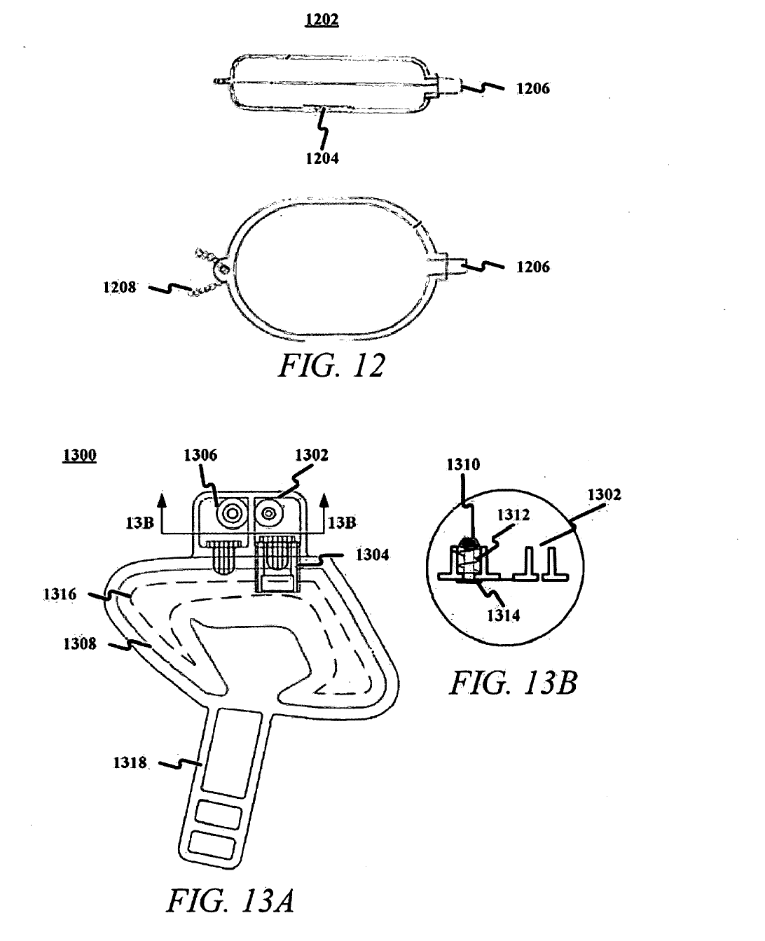

Referring now to FIG. 12, a pump 1202 can be an injection molded plastic with two basic components. First, a valve 1204 (e.g. a check valve) may be used to allow airflow only in one direction (i.e. into pump 1202). When pump 1202 is compressed, valve 1204 restricts airflow and forces airflow through an outlet port 1206. When pump 1202 is release airflow is restricted through outlet port 1206 and valve 1204 allows airflow into pump 1202. Outlet port 1206 is designed to fit into an air inlet port 1302 (See FIGS. 13A and 13B) of an air pouch system 1300 to allow air transfer into air pouch system 1300. Also, a lanyard 1208 can be provided to allow a user to consolidate pump 1202 with other personal effects such as keys. Lanyard 1208 can also be used to allow the user to wear pump 1202 around their neck, etc.

FIGS. 13A and 13B shows air pouch system 1300. Air pouch system 1300 includes a valve 1304 (e.g. a check valve), air inlet port 1302, a pressure release valve 1306, and an air chamber 1308. Air inlet port 1302 is designed to connect to air outlet port 1206. Valve 1304 allows airflow only into air chamber 1308. Air chamber 1308 is designed to store the air introduced via air inlet port 1302 until a valve stem 1310 is depressed. Pressure release valve 1306 includes a spring 1312, a seal 1314 (e.g. an O-ring), and valve stem 1310. Spring 1312 provides recoil to valve stem 1310. Seal 1314 minimizes air leaks from air pouch system 1300. Dotted area 1316 represents a relative size and position of logo 1104 in window 1102. Dotted area 1316 should be encompassed by air chamber 1308 so as to facilitate proper stack operations.

The collective functionality of the individual components includes window 1102 bladder 1004, and air pouch system 1300 are stacked with window 1102 being the outer most layer, air pouch system 1300 being the inner most layer with bladder 1004 sandwiched in between. Note that while this embodiment only describes one bladder and air pouch system, it is contemplated that multiple bladders, windows, and air pouch systems can be used.

The component stack can be secured to apparel in various ways. For example, the component stack can be inserted through an opening into a compartment (e.g. a lining) of apparel. For instance, the component stack can be inserted through an opening into a compartment formed by a sneaker's lining and outer surface. The component stack can also be inserted through an opening into a compartment formed by a purse's lining and out surface. A non-exhaustive list of apparel the component stack could be utilized with includes purses, belts, hats or other headwear, etc.

In other embodiments, elevated logo 1104 could fit through a cut out, possibly also in logo 1104's shape, in the apparel. In addition to apparel's logo cut out, there can also be cut outs in the apparel's wall for air inlet port 1302 and the pressure release valve 1306. After the component stack is inserted as just described and enclosed within the apparel, the only parts of the stack that should be visible are logo 1104, pressure release valve 1306, and air inlet port 1302. It is also contemplated that pressure release valve 1306 and air inlet port 1302 may also be concealed by the apparel. From this perspective logo 1104 appears to be the color of the liquid ink contained within bladder 1004 (this assumes that the initial condition of the stack is with a deflated air pouch system 1300. However, when pump 1202 is connected to air inlet port 1302 and pump 1202 is compressed, the air pressure build up within air chamber 1308 causes the liquid ink to be forced from dotted area 1316 (i.e. to a non-visible area). This allows the rear side color of bladder 1004 to be seen through window 1102, thus giving the effect that the logo color has changed.

While the component stack has been described as inserted into various apparel types, it is contemplated that the component stack could be surface mounted to apparel. For example, the component stack could be mounted to a belt buckle's outer surface. The component stack could also be mounted to the surface of other garments by methods such as adhesives and sewing.

Reference may be made throughout this specification to “one embodiment,” “an embodiment,” “embodiments,” “an aspect,” or “aspects” meaning that a particular described feature, structure, or characteristic may be included in at least one embodiment of the present invention. Thus, usage of such phrases may refer to more than just one embodiment or aspect. In addition, the described features, structures, or characteristics may be combined in any suitable manner in one or more embodiments or aspects. Furthermore, reference to a single item may mean a single item or a plurality of items, just as reference to a plurality of items may mean a single item. Moreover, use of the term “and” when incorporated into a list is intended to imply that all the elements of the list, a single item of the list, or any combination of items in the list has been contemplated.

One skilled in the relevant art may recognize, however, that the invention may be practiced without one or more of the specific details, or with other methods, resources, materials, etc. In other instances, well known structures, resources, or operations have not been shown or described in detail merely to avoid obscuring aspects of the invention.

While example embodiments and applications of the present invention have been illustrated and described, it is to be understood that the invention is not limited to the precise configuration and resources described above. Various modifications, changes, and variations apparent to those skilled in the art may be made in the arrangement, operation, and details of the methods and systems of the present invention disclosed herein without departing from the scope of the claimed invention.

The above specification, examples and data provide a description of the manufacture and use of the invention. Since many embodiments of the invention can be made without departing from the spirit and scope of the invention, the invention resides in the claims hereinafter appended.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

I claim:

1. An apparatus for varying a color of a portion of apparel, the apparatus comprising:
a first reservoir comprising:
a first portion comprising a first dye when the first reservoir is in a first state, and
a second portion comprising the first dye when the first reservoir is in a second state;
a first air pouch proximate the first reservoir.

2. The apparatus of claim 1 further comprising a first fixed filter located proximate to the first reservoir.

3. The apparatus of claim 1, wherein the first reservoir comprises a painted portion.

4. The apparatus of claim 1 further comprising a reflector located proximate the first reservoir.

5. The apparatus of claim 1 further comprising a pump operatively connected to the first air pouch.

6. The apparatus of claim 1 further comprising a second reservoir comprising a second dye located in a first position when the second reservoir is in a first state and the second dye located in a second position when the second reservoir is in a second state.

7. The apparatus of claim 6, wherein the second reservoir comprises a painted portion.

8. The apparatus of claim 6 further comprising a pump operatively connected to the second air pouch.

9. The apparatus of claim 6 further comprising a second fixed filter located proximate the second reservoir.

10. The apparatus of claim 6 further comprising a second reflector located adjacent to the second variable filter.

11. The apparatus of claim 1 further comprising a casing surrounding the first reservoir, and the first air pouch.

12. The apparatus of claim 1, wherein the apparel is one of the following: footwear, headwear, a belt, or a handbag.

13. A method for varying a color of a portion of apparel, the method comprising:
locating a first reservoir on a surface of the apparel; and
passing a first dye from a first opaque portion to a transparent or semitransparent portion, wherein passing the first dye from the first opaque portion to the transparent or semitransparent portion comprises inflating a first air pouch.

14. The method of claim 13 further comprising locating a first fixed filter proximate the transparent or semitransparent portion.

15. The method of claim 13 further comprising:
locating a second reservoir on the surface of the apparel; and
passing a second dye from a second opaque portion to the transparent or semitransparent portion, wherein passing the second dye from the second opaque portion to the transparent or semitransparent portion comprises inflating a second air pouch.

16. The method of claim 15, wherein the apparel comprises one of the following: footwear, headwear, a handbag, or a belt.

17. The method of claim 13, wherein the opaque portion is apparel.

18. Apparel comprising:
a first variable filter comprising:
a first reservoir portion,
a transparent region, and
a first dye located in the first reservoir portion when the variable filter is in a first state and the first dye located in the transparent region when the first variable filter is in a second state; and
a first air pouch proximate the first variable filter.

19. The apparel of claim 18 further comprising a pump having a release valve, the pump fluidly connected to the first air pouch.

20. The apparel of claim 18 further comprising a surface comprising an opening connected to a compartment, the compartment configured to house the first variable filter and the first air pouch.

21. The apparel of claim 20, wherein the compartment is further configured to house a second variable filter.

22. The sneaker of claim 18, wherein the first variable filter is removable from the apparel.
